(19) United States
(12) Patent Application Publication
(10) Pub. No.: US 2023/0407655 A1
(43) Pub. Date: Dec. 21, 2023

(54) AUTOMATED WINDOW-CLEANING DEVICE

(71) Applicants: Sergey Vyacheslavovich KAMYSHNIY, Rostov-on-Don (RU); Viktor Mikhaylovich SHEVCHENKO, Rostov-on-Don (RU)

(72) Inventor: Sergey Vyacheslavovich KAMYSHNIY, Rostov-on-Don (RU)

(21) Appl. No.: 18/037,354

(22) PCT Filed: Dec. 21, 2020
(86) PCT No.: PCT/RU2020/000737

§ 371 Date: May 17, 2023

(30) Foreign Application Priority Data
Sep. 10, 2020 (RU) 2020130431

(51) Int. Cl. E04G 23/00; A47L 1/02; B08B 3/02; B08B 1/00; B08B 13/00

(52) U.S. Cl. CPC E04G 23/002; A47L 1/02; B08B 3/02; B08B 1/008; B08B 1/005; B08B 13/00

(57) ABSTRACT

The invention relates to the field of washing and cleaning building facilities. The aim of the invention is to create an automated device for safely and efficiently cleaning the outside surfaces of windows situated at any height. The present automated window-cleaning device comprises a window frame with glazing, a raising mechanism, a cleaning fluid supply mechanism, and a control unit. The raising mechanism includes two vertical guides fastened on the outside along the edges of the window frame, parallel to one another, each vertical guide having disposed therein a toothed strip mounted on an upper and a lower toothed pulley, wherein the upper toothed pulley is connected to an electric motor. The toothed strip is encircled by an aluminium fork, to which is attached a wiper blade containing a magnet.

### FIELD OF THE INVENTION

The invention relates to the field of washing and cleaning rooms, and particularly to electromechanical devices for cleaning windows from the side of a building facade.

### BACKGROUND OF THE INVENTION

Today, manual window cleaning is the most common; however, it is not safe if windows are above the ground floor of a building. Furthermore, those windows of the building which face busy highways and other dusty areas need to be washed and cleaned frequently. At the same time, manual window cleaning is a laborious process that requires the services of cleaners and, in conditions of high-altitude work, the use of special climbing equipment, which is very expensive and not always reasonable.

RU 147117 A (27 Oct. 2014) discloses a window cleaning device that comprises two vertical screw guides arranged parallel to each other. There is a carriage mounted on each screw guide, which is configured to move along the screw guide under the action of an electric drive. A wiper is mounted between the carriages perpendicular to the screw guides and is configured to press against a window glass. The device is characterized in that the screw guides in their upper and lower parts are mounted on fasteners configured to fasten to a window frame, each of the screw guides is configured to rotate around its axis, each of the screw guides has a first end connected to the shaft of the electric drive that is fixed on the first fastener and a second end inserted into a bearing fixed on the second fastener, and the electric drives are equipped with a reverse sensor configured to change the direction of rotation of the electric drive when the carriage reaches the corresponding fastener. The disadvantages of this device are as follows: the lack of supply of a washing liquid to the window glass, and, consequently, the lack of cleaning efficiency in case of heavy pollution, as well as the impossibility of automatically switching off the operating device.

RU 193740 (13 Nov. 2019) discloses a smart window having a built-in cleaning system, which comprises a frame made of vertical and horizontal profiles, glass and a wiper blade. The smart window is characterized in that the frame comprises a signal receiving unit, a control unit, a power supply unit, a washing liquid reservoir having a pump and channels for a washing liquid. There are also guides for the wiper blade in the vertical profiles of the frame. Motor mechanisms for moving the wiper blade are arranged in the guides. The wiper blade is made of a bar, along the edges of which there are carriages moving along the guides parallel to each other. A cleaning gum is arranged on the bar, and the bar itself is configured to rotate around a longitudinal axis relative to the carriages and to be fixed in various positions. The disadvantage of this smart window is as follows: the complex design of the window, the frame of which comprises the entire washing and cleaning mechanism, thereby allowing the mechanism to be used for cleaning and washing windows only of the type in which this mechanism is installed.

### SUMMARY OF THE INVENTION

It is the object of the invention to provide an automated window cleaning device that allows external washing of any windows located at any height to performed safely and efficiently, as well as simplifies the cleaning process itself due to the automatic supply of a washing liquid to a window glass.

The above object is solved by that the automated window cleaning device comprises a window frame with glass, a lifting mechanism mounted on the outside of a window, as well as a washing liquid supply mechanism and a control unit which are arranged inside a room. The lifting mechanism comprises two vertical guides fixed parallel to each other along the left and right edges of the window frame. Each of the vertical guides has a toothed belt disposed therein. The toothed belt is mounted on toothed pulleys arranged in upper and lower parts of the vertical guide. The upper toothed pulley is connected to an electric motor. The toothed belt is encircled by an aluminum fork, into which two radial bearings are inserted and to which a wiper blade comprising a magnet is attached. At the bottom and top of the left vertical guide, there are limit switches configured to switch the polarity of the electric motors and switch off the window cleaning device. A nozzle is installed in the center of an upper horizontal profile of the window frame, which serves to apply a washing liquid to a glass surface. The washing liquid supply mechanism comprises a channel for supplying the washing liquid to the nozzle, a pump, and a washing liquid reservoir. The window cleaning process is initiated by the control unit which also regulates the amount and time of supply of the washing liquid from the pump to the nozzle.

### BRIEF DESCRIPTION OF THE DRAWINGS

The essence of the invention is explained by the drawings in which:

FIG. 1 shows a lifting mechanism; and

FIG. 2 shows a washing liquid supply mechanism.

### DETAILED DESCRIPTION OF THE INVENTION

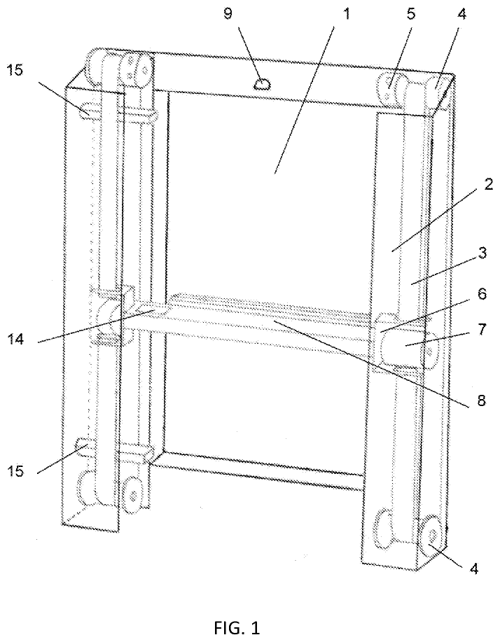

A lifting mechanism of an automated window cleaning device (see FIG. 1) comprises a window frame 1 with glass, on which vertical guides 2 are fixed. There is a toothed belt 3 arranged inside each of the vertical guides. The toothed belt 3 is mounted, on the top and on the bottom, on toothed pulleys 4. The upper toothed pulley is connected to an electric motor 5. The toothed belt is encircled by an aluminum fork 6, into which two radial bearings 7 are inserted and to which a wiper blade 8 comprising a magnet 14 is attached. A nozzle 9 is arranged in the center of an upper horizontal profile of the window frame. There are limit switches 15 at the bottom and top of the left vertical guide.

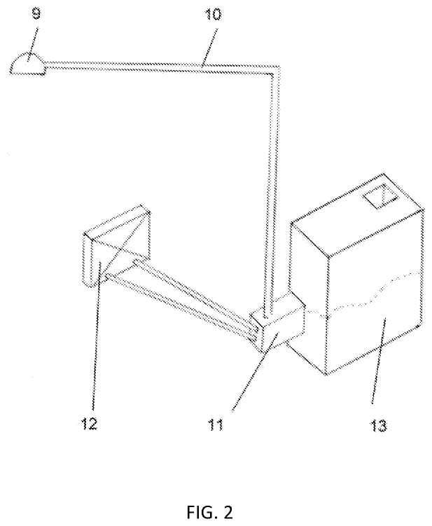

The washing liquid supply mechanism (see FIG. 2) comprises a channel 10 for supplying a washing liquid to the nozzle, a pump 11 connected to a control unit 12, and a washing liquid reservoir 13.

The automated window cleaning device is mounted as follows. At first, the glass is removed from the window frame. Then, on the outside of the window frame, along its edges on the left and right, the vertical guides are mounted parallel to each other. The first toothed pulley is connected to the electric motor arranged in the upper part of the vertical guide. The second toothed pulley is attached to the bottom of the vertical guide. The toothed belt is threaded inside the vertical guides through the upper and lower toothed pulleys and encircled by the aluminum fork. The limit switches are installed at the bottom and top of the left vertical guide. Then, the two radial bearings are inserted into the aluminum fork, whereupon the wiper blade is mounted, the length of which is equal to the width of the window glass. The wiper blade comprises a square tube, on which a framed rubber wiper having adjusting washers is fixed and the magnet is installed. A through hole is made in the center of the upper horizontal profile of the window frame, into which the nozzle is inserted from the outside of the window. The washing liquid reservoir with the pump installed thereon is placed inside the room. The channel for supplying the washing liquid is mounted from the pump to the nozzle. A silicone tube is laid inside the channel, which is put on the nozzle with one side and connected to the pump with the other. In each of the left and right corners of the window frame, one through hole is made, through which wires from the two electric motors and the two limit switches are pulled from the outside into the room. The wires are placed in a cable channel and connected to the control unit mounted on the wall inside the room. Additionally, a wire from the pump and a power wire from the 220 V socket are connected to the control unit. Then, the glass is inserted into the window frame. The wiper blade is adjusted in reach depending on the depth of the window, and a snug fit of the framed rubber wiper is provided using the adjusting washers. After that, the wiper blade takes its original position, namely, it is installed at the level of the upper limit switch of the left vertical guide.

The operation of the automated window cleaning device begins with pressing the “Start” button on the control unit 12, after which the pump 11 is turned on and supplies the washing liquid from the reservoir 13 through the channel 10 to the nozzle 9 that sprays it on the glass surface. The washing liquid is supplied to the nozzle for 2 seconds, and then the pump is turned off. After that, the two electric motors 5 connected to the upper toothed pulley (4) are simultaneously turned on and drive the wiper blade 9 through the toothed belt 3. The wiper blade moves from top to bottom, cleaning the glass surface of dust and dirt, until the magnet present on it reaches the limit switch arranged at the bottom of the left vertical guide. In this case, the polarity of the electric motors is switched, and they begin to operate in the opposite direction, thereby causing the wiper blade to move up, also cleaning the glass surface until the magnet present on it reaches the limit switch arranged at the top of the left vertical guide. The window cleaning device then switches off automatically. The cleaning process can be repeated multiple times until a desired result is achieved.

The invention makes it possible to perform external washing of any windows safely and efficiently, while the lifting mechanism installed outside is practically invisible from the inside of the window.

1. An automated window cleaning device comprising:
a window frame with glass;
a lifting mechanism mounted on the outside of a window;
a washing liquid supply mechanism and a control unit which are arranged inside a room;
wherein the lifting mechanism comprises two vertical guides fixed parallel to each other along left and right edges of the window frame;
wherein each of the vertical guides has a toothed belt disposed therein, the toothed belt being mounted on toothed pulleys arranged in upper and lower parts of the vertical guide, the upper toothed pulley being connected to an electric motor;
wherein the toothed belt is encircled by an aluminum fork into which two radial bearings are inserted and to which a wiper blade comprising a magnet is attached;
wherein, at the bottom and top of the left vertical guide, there are limit switches configured to switch a polarity of the electric motors and switch off the window cleaning device;
wherein a nozzle for spraying a washing liquid to a glass surface is installed in the center of an upper horizontal profile of the window frame;
wherein the washing liquid supply mechanism comprises a channel for supplying the washing liquid to the nozzle, a pump, and a washing liquid reservoir; and
wherein a window cleaning process is initiated by the control unit which also regulates the amount and time of supply of the washing liquid from the pump to the nozzle.

2. The automated window cleaning device of claim 1, wherein the wiper blade is made of a square tube on which the magnet and a framed rubber wiper having adjusting washers are fixed, ensuring a snug fit of the rubber wiper to the glass surface.

3. The automated window cleaning device of claim 1, wherein the wiper blade has a position adjustable in reach depending on a depth of the window.

4. The automated window cleaning device of claim 1, wherein the wiper blade has a length equal to a width of the glass in the window frame.

5. The automated window cleaning device of claim 1, wherein the washing liquid enters the nozzle within 2 seconds.
